(19) United States
(12) Patent Application Publication
(10) Pub. No.: US 2025/0125384 A1
(43) Pub. Date: Apr. 17, 2025

(54) STRUCTURE FOR INCREASING DURABILITY OF ION FILTER

(71) Applicants: HYUNDAI MOTOR COMPANY, Seoul (KR); KIA CORPORATION, Seoul (KR)

(72) Inventors: Myung Hyuk Kim, Suwon-si (KR); Yong Woong Cha, Yongin-si (KR); Ho Chan An, Hwaseong-si (KR); Wan Je Cho, Hwaseong-si (KR); Hae Lee Lee, Seoul (KR); Man Hee Park, Suwon-si (KR); Yeong Jun Kim, Gwangmyeong-si (KR); Jae Yeon Kim, Hwaseong-si (KR); Dong Nyeok Park, Pohang-si (KR)

(21) Appl. No.: 18/422,749

(22) Filed: Jan. 25, 2024

(30) Foreign Application Priority Data
Oct. 16, 2023 (KR) 10-2023-0137496

(51) Int. Cl. H01M 8/04044; H01M 8/04029; H01M 8/04537; H01M 8/04746

(52) U.S. Cl. CPC H01M 8/04044; H01M 8/04029; H01M 8/04634; H01M 8/04649; H01M 8/04768

(57) ABSTRACT

A structure for increasing durability of an ion filter, which includes a reservoir configured to store cooling water discharged from a fuel cell stack, an ion filter configured to remove ions from the cooling water discharged from the fuel cell stack, a flow rate adjustment valve disposed between the ion filter and the fuel cell stack, a first pipe which flows the cooling water from the ion filter to the reservoir, and a second pipe that is a passage through which air or the cooling water is moved between the reservoir and the ion filter according to a change in level of the cooling water inside the ion filter.

### CROSS REFERENCE TO RELATED APPLICATIONS

This application claims under 35 U.S.C. § 119 (a) the benefit of priority to Korean Patent Application No. 10-2023-0137496 filed on Oct. 16, 2023, the entire contents of which are incorporated herein by reference.

### BACKGROUND

### (a) Technical Field

The present disclosure relates to a structure for increasing durability of an ion filter, which can flow cooling water through an ion filter according to the need to remove ions from the cooling water.

### (b) Background Art

A fuel cell stack installed in a fuel cell vehicle produces electric power by combining hydrogen stored in a hydrogen tank and oxygen in the air. During the fuel cell stack producing the electric power, water is produced and heat is generated from the fuel cell stack. The generated electric power is supplied to a driving motor mounted on a vehicle, and the produced water generated in the fuel cell stack is discharged to the outside through an outlet.

The heat generated due to a chemical reaction in the fuel cell stack is discharged into the air through a heat management system including stack cooling water, a cooling water pump, and a radiator. The stack cooling water circulates in components of the heat management system, which is comprised of a radiator, an ion filter, a heater core, and a cooling water pump, through an inside of the fuel cell stack to maintain a uniform temperature inside the fuel cell stack.

It is important that the cooling water circulating in the heat management system maintains an insulating property that does not conduct electricity. When electrical conductivity of the cooling water increases, insulation resistance of the fuel cell stack decreases so that the risk of electric shock and damage to parts increases. When an ion concentration in the cooling water increases, the electrical conductivity increases so that there is a need to configure a heat management system to allow the cooling water to circulate to the ion filter.

However, since the ion filter for removing ions in the cooling water is a consumable item, the ion filter needs to be replaced when a certain period of time or a certain mileage is exceeded. Generally, the ion filter is disposed to be in constant contact with the cooling water circulating in the heat management system, and a cation resin of the ion filter acts as a catalyst to promote oxidation of the cooling water so that the oxidation of the cooling water may be accelerated. Thus, there is a problem in that anions generated as the cooling water is oxidized shorten durability of the ion filter so that a replacement cycle of the ion filter is shortened. In addition, since an ion resin cartridge of the ion filter requires regular replacement, and when the cartridge is replaced, air remaining inside the new ion filter should be removed, there is a problem of occurrence of excessive labor costs.

### SUMMARY

The present disclosure has been made in an effort to solve the above-described problems associated with prior art.

In one aspect, the present disclosure provides a structure for increasing durability of an ion filter, which can flow cooling water through an ion filter according to the need to remove ions from the cooling water.

In another aspect, the present disclosure provides a structure for increasing durability of an ion filter, which can remove ions in the cooling water without air remaining in the ion filter.

Objectives of the present disclosure are not limited to the above-described objectives. The objectives of the present disclosure will become more apparent from the following description and will be implemented by the means described in the appended claims and a combination thereof.

In an exemplary embodiment, the present disclosure provides a structure for increasing durability of an ion filter. The structure for increasing durability of an ion filter includes a reservoir configured to store cooling water discharged from a fuel cell stack, an ion filter configured to remove ions from the cooling water discharged from the fuel cell stack, a flow rate adjustment valve positioned between the ion filter and the fuel cell stack, a first pipe through which the cooling water flows from the ion filter to the reservoir, and a second pipe that is a passage through which air or the cooling water is moved between the reservoir and the ion filter according to a change in level of the cooling water inside the ion filter.

According to one example, the flow rate adjustment valve may be a three-way valve configured to control a flow rate of the cooling water to the ion filter or the reservoir.

According to one example, the flow rate adjustment valve may be configured to introduce the cooling water into the ion filter based on the electrical conductivity of the cooling water or insulation resistance of the fuel cell stack, and when the electrical conductivity of the cooling water or the insulation resistance of the fuel cell stack satisfies a preset condition, the flow rate adjustment valve may be configured to introduce the cooling water into the ion filter and block the cooling water from being introduced into the reservoir.

According to one example, when a level of the cooling water inside the ion filter increases, the air inside the ion filter may be moved to the reservoir, and when the level of cooling water inside the ion filter decreases, the air inside the reservoir may be moved to the ion filter.

According to one example, when the level of cooling water inside the ion filter is higher than or equal to a preset level, the cooling water inside the ion filter may be moved to the reservoir through the second pipe.

According to one example, when the cooling water is not introduced into the ion filter and the level of cooling water inside the ion filter decreases, the cooling water remaining inside the ion filter may be discharged to the reservoir through the first pipe by the air moved from the reservoir to the ion filter.

According to one example, a bottom surface of the ion filter may be positioned higher than a maximum level of the cooling water in the reservoir.

According to one example, the structure may further include an inlet port of the reservoir, which is connected to a first line connecting the fuel cell stack and the reservoir, and an inlet port of the ion filter, which is connected to a second line which branches from the first line and is connected to the ion filter, and a diameter of the inlet port of the ion filter may be greater than a diameter of the first pipe.

According to one example, the flow rate adjustment valve may be an on/off valve positioned on the second line.

In another exemplary embodiment, the present disclosure provides a structure for increasing durability of an ion filter. The structure for increasing durability of an ion filter includes a reservoir configured to store cooling water discharged from a fuel cell stack, an ion filter configured to remove ions from the cooling water discharged from the fuel cell stack, and a flow rate adjustment valve configured to control flow of the cooling water, which is discharged from the fuel cell stack, to at least one of the ion filter or the reservoir, wherein the ion filter includes an outlet port configured to control the flow of the cooling water to the reservoir, and a flow port through which air or the cooling water is moved between the reservoir and the ion filter, and the outlet port and the flow port are directly connected to the reservoir.

According to one example, the air may be moved between the reservoir and the ion filter through the flow port according to a change in level of the cooling water inside the ion filter.

According to one example, the flow rate adjustment valve may include a first port directly connected to the ion filter and configured to control flow of the cooling water to the ion filter, and a second port directly connected to the reservoir and configured to control the flow of the cooling water to the reservoir, and the ion filter may include an inlet port connected to the first port of the flow rate adjustment valve and configured to introduce the cooling water.

According to one example, the flow port may be positioned higher than the outlet port based on a bottom surface of the ion filter, and the bottom surface of the ion filter may be inclined based on a maximum level of the cooling water in the reservoir.

In still another exemplary embodiment, the present disclosure provides a structure for increasing durability of an ion filter. The structure for increasing durability of an ion filter includes a reservoir configured to store cooling water discharged from a fuel cell stack, an ion filter configured to remove ions from the cooling water discharged from the fuel cell stack, a flow rate adjustment valve positioned between the ion filter and the fuel cell stack, and a flow component configured to discharge air in the ion filter, introduce the air into the ion filter, or control flow of the cooling water from the ion filter to the reservoir according to a change in a level of cooling water inside the ion filter, wherein the ion filter includes an inlet port connected to the flow rate adjustment valve, and an outlet port configured to discharge the cooling water to a line through which the cooling water discharged from the reservoir flows.

According to one example, the structure may further include a first line through which the cooling water flows, which is discharged from the fuel cell stack, to the reservoir, a second line which branches from the first line and through which the cooling water flows to the ion filter, a third line through which the cooling water flows, which is discharged from the reservoir, to a cooling water pump, and a fourth line connected to the third line to connect to the outlet port of the ion filter.

According to one example, the flow rate adjustment valve may be a three-way valve positioned at a point connecting the first line and the second line or the flow rate adjustment valve may be an on/off valve disposed on the second line.

According to one example, a cooling water open/close valve may be provided on the fourth line to control a flow of the cooling water discharged from the ion filter.

According to one example, when the cooling water is not introduced into the ion filter by the flow rate adjustment valve, the cooling water open/close valve may be closed when the level of the cooling water in the ion filter is lower than a preset lower limit level.

According to one example, the flow component may be a passage which connects the reservoir and the ion filter and through which the air or cooling water is moved between the reservoir and the ion filter.

According to one example, the flow component may be a relief valve configured to discharge the air inside the ion filter to the outside or introduce the air into the ion filter.

Other aspects and preferred embodiments of the present disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a heat management system including a structure for increasing durability of an ion filter according to an embodiment of the present disclosure;

FIG. 2 is a block diagram for describing a method of controlling the structure for increasing durability of an ion filter according to an embodiment of the present disclosure;

FIG. 3 is a diagram illustrating the structure for increasing durability of an ion filter according to one embodiment of the present disclosure;

FIG. 4 is a diagram illustrating a structure for increasing durability of an ion filter according to another embodiment of the present disclosure;

FIG. 5 is a diagram illustrating a structure for increasing durability of an ion filter according to still another embodiment of the present disclosure;

FIG. 6 is a diagram illustrating a structure for increasing durability of an ion filter according to yet another embodiment of the present disclosure;

FIG. 7 is a diagram illustrating the structure for increasing durability of the ion filter of FIG. 6 from another perspective;

FIG. 8 is a diagram illustrating a structure for increasing durability of an ion filter according to yet another embodiment of the present disclosure;

FIG. 9 is a diagram illustrating a structure for increasing durability of an ion filter according to yet another embodiment of the present disclosure; and

FIG. 10 is a diagram illustrating a structure for increasing durability of an ion filter according to yet another embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The advantages and features of the present disclosure and a manner for achieving them will become apparent with reference to the embodiments described in detail below together with the accompanying drawings. The present disclosure may, however, be implemented in many different forms and should not be construed as being limited to the embodiments set forth herein, and the embodiments are provided such that this disclosure will be thorough and complete and will fully convey the scope of the present disclosure to those skilled in the art, and the present disclosure is defined by only the scope of the appended claims. The same reference numerals refer to the same components throughout this disclosure.

Further, in the present specification, the terms a first, a second, and the like are assigned to components so as to discriminate these components because names of the components are the same, but these terms are not necessarily limited to the order in the following description.

The foregoing detailed description illustrates the present disclosure. Further, the foregoing is intended to illustrate and describe the exemplary embodiments of the present disclosure, and the present disclosure may be used in various other combinations, modifications, and environments. That is, it is possible to practice alternations or modifications without departing from the scope of the present disclosure disclosed herein, equivalents, and/or within the technical or knowledge scope in the art to which the present disclosure pertains. The described embodiments are intended to illustrate the best mode for carrying out the technical spirit of the present disclosure and various modification can made in the specific applications and uses of the present disclosure. Therefore, the detailed description is not intended to limit the present disclosure as in the disclosed embodiments. Further, it should be construed that the appended claims are intended to include another embodiment.

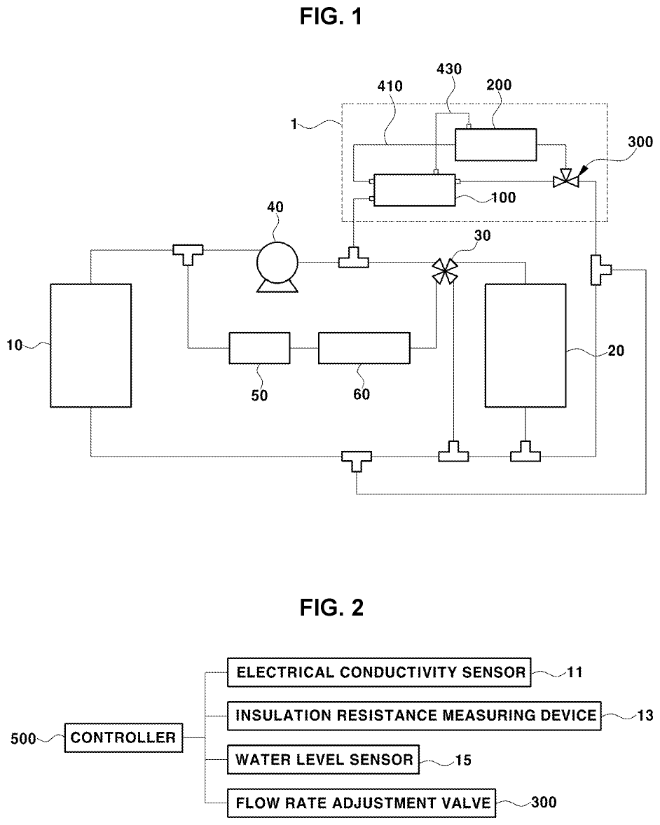

FIG. 1 is a diagram illustrating a heat management system including a structure for increasing durability of an ion filter according to an embodiment of the present disclosure.

Referring to FIG. 1, a fuel cell heat management system may include a fuel cell stack 10, a radiator 20, an integrated control valve 30, a cooling water pump 40, a cathode oxygen depletion (COD) heater 50, a heater core 60, and a structure 1 for increasing durability of an ion filter. The fuel cell heat management system is to remove reaction heat of the fuel cell stack 10 using cooling water, control an operating temperature of the fuel cell stack 10, and perform a water management function.

The fuel cell stack 10 may receive air and hydrogen to produce electrical power through a chemical reaction. In order to radiate heat that is a by-product generated by the chemical reaction of the fuel cell stack 10, the cooling water may be introduced into the fuel cell stack 10.

The radiator 20 may re-cool the cooling water heated after the chemical reaction of the fuel cell stack 10. The cooled cooling water may flow to the integrated control valve 30.

The integrated control valve 30 may control an opening and closing of a valve according to a control mode of the fuel cell heat management system. For example, the integrated control valve 30 may be a four-way valve, and a type of the integrated control valve 30 may not be particularly limited. The cooling water may be introduced into the integrated control valve 30 from the fuel cell stack 10, the radiator 20, and the heater core 60, and the cooling water may flow from the integrated control valve 30 toward the cooling water pump 40. A flow rate and a flow direction of the cooling water may be controlled according to the opening and closing of the integrated control valve 30.

The cooling water pump 40 may supply the cooling water, which is transferred from the integrated control valve 30, to the fuel cell stack 10 or the COD heater 50.

The COD heater 50 may consume the electrical power generated by the fuel cell stack 10 in order to increase a temperature of the cooling water when heating of the cooling water is required or to lower a voltage of the fuel cell stack 10. In particular, when regenerative braking is continuously performed when a starting of the fuel cell system is turned on or off and a state of charge (SOC) of a high voltage battery is sufficient, the COD heater 50 may be operated to consume the electrical power generated from the fuel cell stack 10.

The heater core 60 may be connected to a rear end of the COD heater 50. In order to heat an interior of the vehicle, the heater core 60 may transfer the heat of the cooling water to an air conditioning device (not shown). The heater core 60 may perform heat exchange between the cooling water heated by the COD heater 50 and outdoor air. The cooling water passing through the heater core 60 may be introduced into the integrated control valve 30.

The structure 1 for increasing durability of an ion filter may include a reservoir 100, an ion filter 200, and a flow rate adjustment valve 300. The reservoir 100 may store the cooling water circulating in the heat management system. The cooling water discharged from the fuel cell stack 10 may be introduced into the reservoir 100 or the ion filter 200 through the flow rate adjustment valve 300. The flow rate adjustment valve 300 may flow the cooling water discharged from the fuel cell stack 10 to either the reservoir 100 or the ion filter 200. Thus, the flow rate adjustment valve 300 may be disposed between the fuel cell stack 10 and the reservoir 100 or between the fuel cell stack 10 and the ion filter 200. For example, the flow rate adjustment valve 300 may be a three-way valve, but the present disclosure may not be particularly limited thereto.

The ion filter 200 may remove ions from the cooling water discharged from the fuel cell stack 10. The ion filter 200 may be disposed at a rear end of the flow rate adjustment valve 300. The ion filter 200 may be connected to the reservoir 100 through a first pipe 410. The cooling water whose ions are removed through the ion filter 200 may introduced into the reservoir 100 through the first pipe 410. The air or cooling water remaining inside the ion filter 200 may be moved through a second pipe 430 according to a change in level of the cooling water inside the ion filter 200. The second pipe 430 may serve as a passage through which the air or cooling water moves by connecting the reservoir 100 and the ion filter 200. The cooling water and the air, which are introduced into the reservoir 100, may flow to the cooling water pump 40.

According to the embodiment of the present disclosure, since cooling water may be prevented always from being introduced into the ion filter 200 through the flow rate adjustment valve 300, durability of the ion filter 200 can be improved.

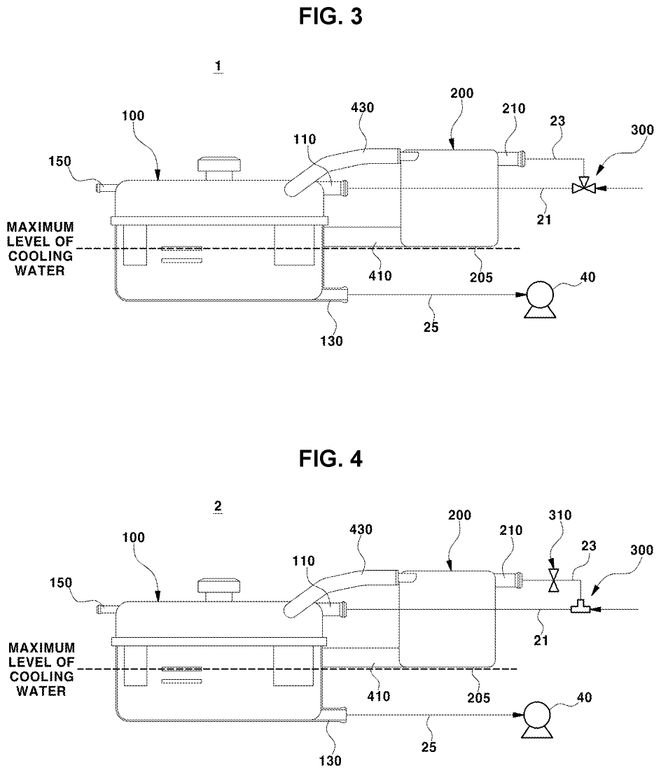

FIG. 2 is a block diagram for describing a method of controlling the structure for increasing durability of an ion filter according to an embodiment of the present disclosure, and FIG. 3 is a diagram illustrating the structure for increasing durability of an ion filter according to one embodiment of the present disclosure.

Referring to FIGS. 1 to 3, the ion filter 200 may be disposed above the reservoir 100 based on an arrangement position of the structure 1 for increasing durability of an ion filter. A maximum level at which the cooling water may be introduced into the reservoir 100 may be determined in advance. A bottom surface 205 of the ion filter 200 may be disposed at a position that is higher than or equal to the maximum level of the cooling water in the reservoir 100. Thus, a back flow of the cooling water from the reservoir 100 to the ion filter 200 may be prevented.

The reservoir 100 may include an inlet port 110 connected to a first line 21 which connects the flow rate adjustment valve 300 or the fuel cell stack 10 to the reservoir 100, an outlet port 130 connected to a third line 25 which connects the cooling water pump 40 and the reservoir 100, and a degassing port 150 connected to an inlet manifold of the fuel cell stack 10 or the radiator 20. The degassing port 150 may be connected to the outlet manifold of the fuel cell stack 10 or the radiator 20, where there is a high possibility of stagnant air, and connected to a line for flowing the stagnant air and the cooling water into the reservoir 100.

The ion filter 200 may include an inlet port 210 connected to a second line 23 which connects the flow rate adjustment valve 300 and the ion filter 200. The first pipe 410 and the second pipe 430, which connect the ion filter 200 and the reservoir 100, may be disposed at positions that are higher than or equal to the maximum level of the cooling water in the reservoir 100. The second pipe 430 may be disposed at a position that is higher than a position of the first pipe 410. In order to lower a flow rate of the cooling water discharged from the ion filter 200 to be smaller than a flow rate of the cooling water introduced into the ion filter 200, a diameter of the inlet port 210 of the ion filter 200 may be greater than a diameter of the first pipe 410. Through the difference between the diameter of the inlet port 210 of the ion filter 200 and the diameter of the first pipe 410, the cooling water may be prevented from being introduced into the reservoir 100 in a state in which the ions in the cooling water are not removed by the ion filter 200.

Since the reservoir 100 and the ion filter 200 are connected through the second pipe 430 through which air moves, the reservoir 100 and the ion filter 200 are exposed to the same air pressure. Therefore, the sum of an amount of contained water and an amount of the air in the cooling water in the reservoir 100 and the ion filter 200 may be kept constant always.

The flow rate adjustment valve 300 may be a three-way valve, and the second line 23 may be a line branching from the first line 21. The flow rate adjustment valve 300 may directly flow the cooling water, which is discharged from the fuel cell stack 10, to the reservoir 100 or may flow the cooling water to the ion filter 200. The flow rate adjustment valve 300 may be controlled by a controller 500 of the heat management system. The controller 500 may determine electrical conductivity of the cooling water circulating in the heat management system through an electrical conductivity sensor 11 or based on a change in insulation resistance of the fuel cell stack 10, which is measured through an insulation resistance measuring device 13. The controller 500 may detect a level change of the cooling water inside the ion filter 200 through a water level sensor 15 provided in the ion filter 200. The controller 500 may determine whether the cooling water is to pass through the ion filter 200 by controlling the flow rate adjustment valve 300 based on the electrical conductivity of the cooling water. The structure 1 for increasing durability of an ion filter may be controlled by a bypass mode in which the cooling water is introduced into only the reservoir 100 and thus is not introduced into the ion filter 200, an ion filter injection mode meaning an initial introduction of the cooling water into the ion filter 200, an ion filtering mode meaning a state in which a level of the cooling water in the ion filter 200 is higher than or equal to a preset level after the cooling water is introduced into the ion filter 200, and an ion filter discharge mode in which the cooling water inside the ion filter 200 is discharged to the outside of the ion filter 200.

According to one example, the bypass mode may mean a case in which there is no need to flow the cooling water to the ion filter 200 according to the electrical conductivity of the cooling water. The controller 500 may control the flow rate adjustment valve 300 to flow the cooling water, which is discharged from the fuel cell stack 10, to the reservoir 100. The sum of a flow rate of the cooling water introduced through the inlet port 110 of the reservoir 100 and a flow rate of the cooling water introduced through the degassing port 150 may always be the same as a flow rate discharged through the outlet port 130 of the reservoir 100.

According to one example, the ion filter injection mode may mean a case in which there is a need to flow the cooling water to the ion filter 200 according to the electrical conductivity of the cooling water. The controller 500 may control the flow rate adjustment valve 300 to flow the cooling water, which is discharged from the fuel cell stack 10, to the ion filter 200. A case in which there is a need to flow the cooling water to the ion filter 200 according to the electrical conductivity of the cooling water means a case in which the electrical conductivity of the cooling water or the insulation resistance of the fuel cell stack 10 satisfies a preset condition so that this may mean a case in which the electrical conductivity is greater than or equal to a preset conductivity value or the insulation resistance of the fuel cell stack 10 is less than or equal to a preset insulation resistance value. The flow rate adjustment valve 300 may be controlled to introduce the cooling water into the ion filter 200 and block the cooling water from being introduced into the reservoir 100. Since a diameter of the inlet port 210 of the ion filter 200 is greater than a diameter of the first pipe 410, the level of the cooling water in the ion filter 200 may increase. As the level of the cooling water inside the ion filter 200 increases, air present in the ion filter 200 may be moved to the reservoir 100 through the second pipe 430. Since the cooling water is continuously discharged from the outlet port 130 of the reservoir 100 to the cooling water pump 40, the level of the cooling water in the reservoir 100 may decrease. That is, the air may be moved from the ion filter 200 to the reservoir 100 by as much as an increase or decrease amount of the cooling water in the reservoir 100 and the ion filter 200.

According to one example, the ion filtering mode may mean a case in which the level of the cooling water in the ion filter 200 is higher than or equal to a preset level during a process of flowing the cooling water to the ion filter 200. In this case, the cooling water inside the ion filter 200 may be moved to the reservoir 100 through the second pipe 430. When the level of the cooling water in the ion filter 200 continues to rise even after all the air in the ion filter 200 is moved to the reservoir 100, the second pipe 430 may serve as a passage for moving the cooling water rather than the air. In order to prevent the air from being introduced into the cooling water pump 40 from the reservoir 100, an internal volume of the reservoir 100 may be determined by considering a water containing amount of the ion filter 200. Specifically, in a state in which the ion filter 200 is maximally filled with the cooling water, the internal volume of the reservoir 100 may be determined to secure a minimum level of the cooling water in the reservoir 100.

According to one example, the ion filter discharge mode may mean a case in which the electrical conductivity of the cooling water does not satisfy the preset condition due to the ion filter 200. The controller 500 may determine that there is no need for the cooling water to be introduced into the ion filter 200 and control the flow rate adjustment valve 300 to flow the cooling water to the reservoir 100. That is, the flow rate adjustment valve 300 may be controlled to introduce the cooling water into the reservoir 100 and block the cooling water from being introduced into the ion filter 200. Thus, the level of the cooling water in the ion filter 200 may decrease, and the level of the cooling water in the reservoir 100 may increase. As the level of the cooling water in the ion filter 200 decreases, the air in the reservoir 100 may be moved to the ion filter 200 through the second pipe 430. As the air in the reservoir 100 is moved to the ion filter 200 through the second pipe 430, the cooling water remaining in the ion filter 200 may be moved to the reservoir 100.

According to the embodiment of the present disclosure, after the removal of the ions from the cooling water is completed according to a flow of the air moved from the reservoir 100 to the ion filter 200 through the second pipe 430, the cooling water remaining in the ion filter 200 may be moved to the reservoir 100. Thus, a time during which the ion filter 200 is exposed to the cooling water may be reduced so that durability of the ion filter 200 can be improved.

FIG. 4 is a diagram illustrating a structure for increasing durability of an ion filter according to another embodiment of the present disclosure. For simplicity of description, a description overlapping with FIG. 3 will be omitted.

Referring to FIG. 4, a structure 2 for increasing durability of an ion filter may include a flow rate adjustment valve 310 configured to control a flow of cooling water to an ion filter 200. A second line 23 connected to the ion filter 200 may be a line branching from a first line 21 flowing the cooling water from a fuel cell stack to a reservoir 100. The flow rate adjustment valve 310 may be a two-way valve, and the flow rate adjustment valve 310 may be disposed on the second line 23. The flow rate adjustment valve 310 may control an introduction of the cooling water, which is discharged from the fuel cell stack, into the ion filter 200. For example, the flow rate adjustment valve 310 may be an on/off valve. Since a separate valve is not disposed on the first line 21, the cooling water may always be introduced into the reservoir 100.

Based on electrical conductivity of the cooling water circulating in a heat management system or insulation resistance of the fuel cell stack, it can be determined whether the cooling water is to be introduced into the ion filter 200. That is, the flow rate adjustment valve 310 may be controlled based on the necessity of removal of ions from the cooling water through the ion filter 200.

According to one example, in the bypass mode in which there is no need to flow the cooling water to the ion filter 200 according to the electrical conductivity of the cooling water, the flow rate adjustment valve 310 may be controlled to prevent the cooling water from being introduced into the ion filter 200.

According to one example, in the ion filter injection mode in which it is necessary to flow the cooling water to the ion filter 200 according to the electrical conductivity of the cooling water, the flow rate adjustment valve 310 may be opened to flow the cooling water to the ion filter 200. In this case, since the first line 21 is always in an opened state, the cooling water discharged from fuel cell stack 10 may also be introduced into the reservoir 100. Since a diameter of an inlet port 210 of the ion filter 200 is greater than a diameter of a first pipe 410, a level of the cooling water in the ion filter 200 may increase. As the level of the cooling water inside the ion filter 200 increases, air present in the ion filter 200 may be moved to the reservoir 100 through a second pipe 430. Although the cooling water is introduced into the reservoir 100 through an inlet port 110 of the reservoir 100, since the cooling water is continuously discharged from an outlet port 130 of the reservoir 100 to a cooling water pump 40, the level of the cooling water in the reservoir 100 may decrease. That is, the air may be moved from the ion filter 200 to the reservoir 100 by as much as an increase or decrease amount of the cooling water in the reservoir 100 and the ion filter 200.

According to one example, in the ion filtering mode in which the level of the cooling water in the ion filter 200 is higher than or equal to a preset level during a process in which the cooling water is introduced into the ion filter 200, the cooling water inside the ion filter 200 may be moved to the reservoir 100 through the second pipe 430. When the level of cooling water in the ion filter 200 continues to rise even after all the air in the ion filter 200 is moved to the reservoir 100, the second pipe 430 may serve as a passage for moving the cooling water rather than the air. In order to prevent the air from being introduced into the cooling water pump 40 from the reservoir 100, an internal volume of the reservoir 100 may be determined by considering a water containing amount of the ion filter 200. Specifically, in a state in which the ion filter 200 is maximally filled with the cooling water, the internal volume of the reservoir 100 may be determined to secure a minimum level of the cooling water in the reservoir 100.

According to one example, in the ion filter discharge mode in which the electrical conductivity of the cooling water does not satisfy a preset condition due to the ion filter 200, the flow rate adjustment valve 310 may be closed to prevent the cooling water from being introduced into the ion filter 200. Thus, the level of the cooling water in the ion filter 200 may decrease, and the level of the cooling water in the reservoir 100 may increase. As the level of the cooling water in the ion filter 200 decreases, the air in the reservoir 100 may be moved to the ion filter 200 through the second pipe 430. As the air in the reservoir 100 is moved to the ion filter 200 through the second pipe 430, the cooling water remaining in the ion filter 200 may be moved to the reservoir 100.

According to the embodiment of the present disclosure, after the removal of the ions from the cooling water is completed according to a flow of the air moved from the reservoir 100 to the ion filter 200 through the second pipe 430, the cooling water remaining in the ion filter 200 may be moved to the reservoir 100. Thus, a time during which the ion filter 200 is exposed to the cooling water may be reduced so that durability of the ion filter 200 can be improved.

According to the embodiment of the present disclosure, the valve for controlling a flow path of the cooling water to the reservoir 100 and the ion filter 200 may be employed as a two-way valve or an on/off valve rather than a three-way valve so that the cost of constructing the structure 2 for increasing durability of an ion filter can be reduced.

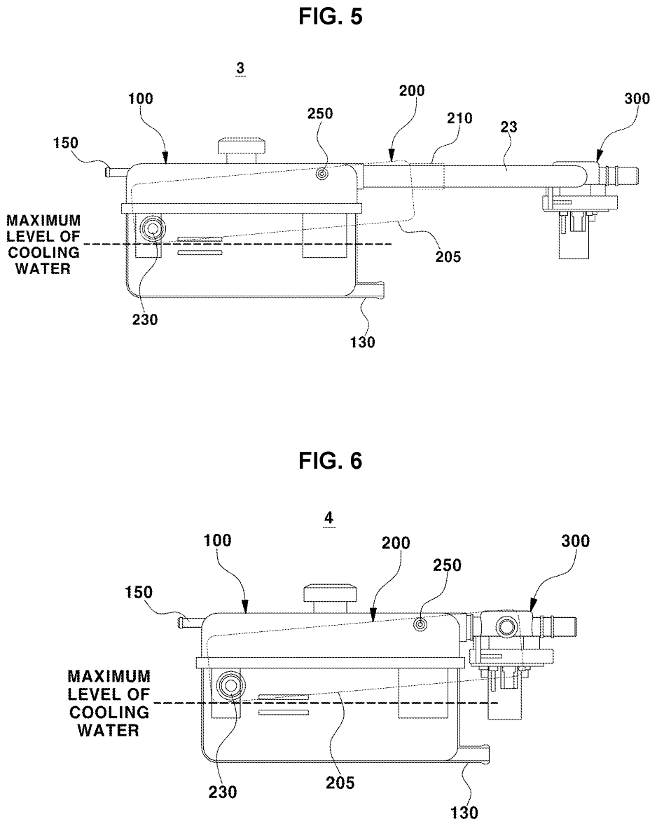

FIG. 5 is a diagram illustrating a structure for increasing durability of an ion filter according to yet another embodiment of the present disclosure. For simplicity of description, an overlapping description will be omitted. In order to describe a connection relationship between a reservoir and an ion filter, only an outline of the ion filter is shown in FIG. 5.

Referring to FIG. 5, a structure 3 for increasing durability of an ion filter may be formed in a structure in which a reservoir 100 and an ion filter 200 are modularizes. The ion filter 200 may include an inlet port 210 connected to a second line 23 which connects a flow rate adjustment valve 300 and an ion filter 200, an outlet port 230 configured to flow cooling water to the reservoir 100, and a flow port 250 that is a passage through which air or the cooling water is moved between the reservoir 100 and the ion filter 200. The outlet port 230 and the flow port 250 may be directly connected to the reservoir 100. Therefore, a pipe for connecting the reservoir 100 and the ion filter 200 may be omitted so that the cost of manufacturing the structure 3 for increasing durability of an ion filter can be reduced, and a total weight of the structure 3 for increasing durability of an ion filter can be reduced. However, the flow rate adjustment valve 300 may be connected to the reservoir 100 through a first line (not shown) and may be connected to the ion filter 200 through the second line 23. As one example, the flow rate adjustment valve 300 may be a three-way valve, but the present disclosure may not be particularly limited thereto.

The ion filter 200 may be disposed above the reservoir 100 based on an arrangement position of the structure 3 for increasing durability of an ion filter. A bottom surface 205 of the ion filter 200 may be disposed at a position that is higher than or equal to the maximum level of the cooling water in the reservoir 100. The outlet port 230 and the flow port 250 may be disposed at positions that are higher than or equal to the maximum level of the cooling water in the reservoir 100. The flow port 250 is a port serving as a passage through which the air is moved mainly and may be provided at a position that is higher than the outlet port 230 based on the bottom surface of the ion filter 200. The bottom surface of the ion filter 200 may be inclined based on the maximum level of the cooling water in the reservoir 100.

When the level of cooling water inside the ion filter 200 increases, air inside the ion filter 200 may be moved to the reservoir 100 through the flow port 250. As the level of the cooling water in the ion filter 200 decreases, the air inside the reservoir 100 may be moved to the ion filter 200 through the flow port 250. When the cooling water is not introduced into the ion filter 200 after the ion removal mode in the cooling water is released by the ion filter 200, the air inside the reservoir 100 may be moved to the ion filter 200 through the flow port 250, and thus the cooling water remaining in the ion filter 200 may be discharged to the reservoir 100. Thus, a time during which the ion filter 200 is exposed to the cooling water may be reduced so that durability of the ion filter 200 can be improved.

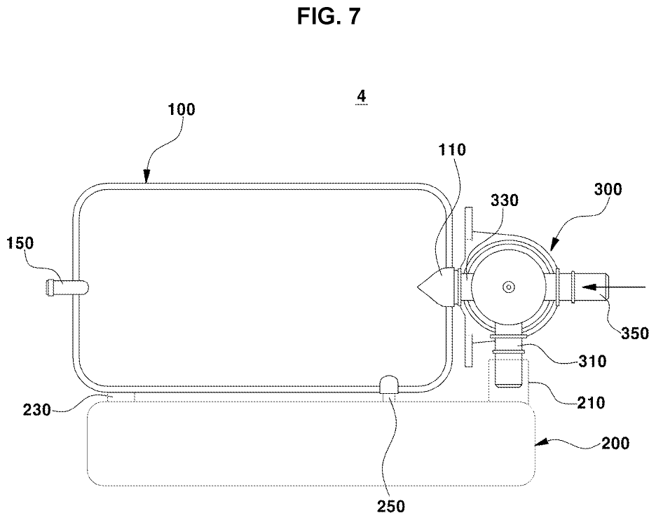

FIG. 6 is a diagram illustrating a structure for increasing durability of an ion filter according to yet another embodiment of the present disclosure, and FIG. 7 is a diagram illustrating the structure for increasing durability of the ion filter of FIG. 6 from another perspective. For simplicity of description, a detailed description overlapping with that of FIG. 5 will be omitted. In order to describe a connection relationship between a reservoir and an ion filter, only an outline of the ion filter is shown in FIG. 6.

Referring to FIGS. 6 and 7, a structure 4 for increasing durability of an ion filter may be formed in a structure in which all of a reservoir 100, an ion filter 200, and a flow rate adjustment valve 300 are modularized. The ion filter 200 may include an inlet port 210 connected to the flow rate adjustment valve 300, an outlet port 230 configured to flow cooling water to the reservoir 100, and a flow port 250 that is a passage through which air or the cooling water is moved between the reservoir 100 and the ion filter 200. The outlet port 230 and the flow port 250 may be directly connected to the reservoir 100, and the inlet port 210 may be directly connected to the flow rate adjustment valve 300. The flow rate adjustment valve 300 may include a first port 310 directly connected to the ion filter 200 and configured to flow the cooling water to the ion filter 200, a second port 330 directly connected to the reservoir 100 and configured to flow the cooling water to the reservoir 100, and a third port 350 connected to a line through which the cooling water discharged from the fuel cell stack flows. The first port 310 of the flow rate adjustment valve 300 may be connected to the inlet port 210 of the ion filter 200, and the second port 330 of the flow rate adjustment valve 300 may be connected to an inlet port 110 of the reservoir 100. As one example, the flow rate adjustment valve 300 may be a three-way valve.

The ion filter 200 may be disposed above the reservoir 100 based on an arrangement position of the structure 4 for increasing durability of an ion filter. A bottom surface 205 of the ion filter 200 may be disposed at a position that is higher than or equal to the maximum level of the cooling water in the reservoir 100. The outlet port 230 and the flow port 250 may be disposed at positions that are higher than or equal to the maximum level of the cooling water in the reservoir 100. The flow port 250 is a port serving as a passage through which the air is moved mainly and may be provided at a position that is higher than the outlet port 230 based on the bottom surface of the ion filter 200.

The ion filter 200 may include an inlet port 210 connected to the flow rate adjustment valve 300, an outlet port 230 configured to move the cooling water to the reservoir 100, and a flow port 250 configured to move the air or cooling water in conjunction with the reservoir 100. When a level of the cooling water in the ion filter 200 increases, air inside the ion filter 200 may be moved to the reservoir 100 through the flow port 250. When the level of cooling water in the ion filter 200 decreases, the air may be moved from the reservoir 100 to the ion filter 200 through the flow port 250. Thus, when the cooling water is not introduced into the ion filter 200 after ions in the cooling water are removed through the ion filter 200, the air inside the reservoir 100 may be moved to the ion filter 200, and thus the cooling water remaining in the ion filter 200 may be moved to the reservoir 100. Thus, a time during which the ion filter 200 is exposed to the cooling water may be reduced so that durability of the ion filter 200 can be improved.

According to the embodiment of the present disclosure, a pipe for connecting the reservoir 100, the ion filter 200, and the flow rate adjustment valve 300 may be omitted so that the cost of manufacturing the structure 4 for increasing durability of an ion filter can be reduced, and a total weight of the structure 4 for increasing durability of an ion filter can be reduced. That is, according to the embodiment of the present disclosure, the structure in which the reservoir 100, the ion filter 200, and the flow rate adjustment valve 300 are modularized may be implemented.

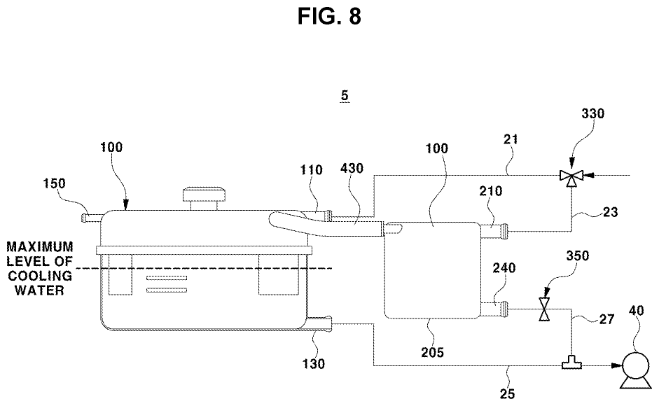

FIG. 8 is a diagram illustrating a structure for increasing durability of an ion filter according to yet another embodiment of the present disclosure.

Referring to FIG. 8, an ion filter 200 applied to a structure 5 for increasing durability of an ion filter may include an inlet port 210 connected to a second line 23 through which cooling water flows from a flow rate adjustment valve 330, an outlet port 240 connected to a fourth line 27 configured to discharge the cooling water from the ion filter 200 to a cooling water pump 40, and a flow component 430 configured to move the air or cooling water in conjunction with the reservoir 100. As one example, the flow component 430 may be a pipe connecting the reservoir 100 and the ion filter 200. The flow component 430 may discharge the air inside the ion filter 200 to the reservoir 100, introduce the air into the ion filter 200, or flow the cooling water from the ion filter 200 to the reservoir 100 according to a change in level of the cooling water inside the ion filter 200.

The flow rate adjustment valve 330 may serve to flow the cooling water, which is discharged from the fuel cell stack, to the reservoir 100 or the ion filter 200. The flow rate adjustment valve 330 may be a three-way valve disposed in front of the reservoir 100 and the ion filter 200. The flow rate adjustment valve 330 may be connected to the reservoir 100 through a first line 21, and the first line 21 may be connected to an inlet port 110 of the reservoir 100. A second line 23 is a line branching from the first line 21 and may be connected to the flow rate adjustment valve 330. That is, the flow rate adjustment valve 300 may be disposed at a point connecting the first line 21 and the second line 23.

The reservoir 100 may include an outlet port 130 for discharging the cooling water toward the cooling water pump 40. The outlet port 130 may be connected to a third line 25 connected to the cooling water pump 40. The fourth line 27 may be connected to the third line 25 and may supply the cooling water, which is discharged from the ion filter 200, to the third line 25. A cooling water open/close valve 350 may be provided on the fourth line 27 to control a flow of the cooling water discharged from the ion filter 200. For example, the cooling water open/close valve 350 may be an on/off valve.

A bottom surface 205 of the ion filter 200 may be positioned below a maximum level of the cooling water of the reservoir 100. Ideally, the bottom surface 205 of ion filter 200 should be positioned above the maximum level of the cooling water in reservoir 100. However, when the bottom surface 205 of the ion filter 200 is positioned below the maximum level of the cooling water of the reservoir 100 in an layout of the structure 5 for increasing durability of an ion filter, in order to prevent the cooling water from flowing back from the reservoir 100 to the ion filter 200, an outlet port 240 of the ion filter 200 may be connected to the cooling water pump 40 rather than the reservoir 100.

According to one example, in the bypass mode in which there is no need to flow the cooling water to the ion filter 200 according to the electrical conductivity of the cooling water, the flow rate adjustment valve 330 may be controlled to flow the cooling water, which is discharged from the fuel cell stack, to the reservoir 100. The sum of a flow rate of the cooling water introduced through the inlet port 110 of the reservoir 100 and a flow rate of the cooling water introduced through the degassing port 150 may always be the same as a flow rate discharged through the outlet port 130 of the reservoir 100. The cooling water open/close valve 350 may be in a closed state.

According to one example, in the ion filter injection mode in which there is a need to flow the cooling water to the ion filter 200 according to the electrical conductivity of the cooling water, the flow rate adjustment valve 330 may be controlled to flow the cooling water, which is discharged from the fuel cell stack, to the ion filter 200. A case in which there is a need to flow the cooling water to the ion filter 200 according to the electrical conductivity of the cooling water means a case in which the electrical conductivity of the cooling water or the insulation resistance of the fuel cell stack 10 satisfies a preset condition so that this may mean a case in which the electrical conductivity is greater than or equal to a preset conductivity value or the insulation resistance of the fuel cell stack is less than or equal to a preset insulation resistance value. The flow rate adjustment valve 330 may be controlled to introduce the cooling water into the ion filter 200 and block the cooling water from being introduced into the reservoir 100. As the cooling water open/close valve 350 disposed on the fourth line 27 connected to the ion filter 200 is closed, the level of the cooling water in the ion filter 200 may increase. As the level of the cooling water inside the ion filter 200 increases, the air present in the ion filter 200 may be moved to the reservoir 100 through the flow component 430. Since the cooling water is continuously discharged from the outlet port 130 of the reservoir 100 to the cooling water pump 40, the level of the cooling water in the reservoir 100 may decrease. That is, the air may be moved from the ion filter 200 to the reservoir 100 by as much as an increase or decrease amount of the cooling water in the reservoir 100 and the ion filter 200. In order to prevent the air inside the ion filter 200 from being introduced into the cooling water pump 40, the cooling water may be continuously introduced into the ion filter 200 until the cooling water inside the ion filter 200 reaches a preset level. In this case, the cooling water open/close valve 350 may remain in the closed state. A time during which the cooling water is introduced into the ion filter 200 may be determined through a preset time according to the number of revolutions of the cooling water pump 40 or through a water level sensor positioned inside the ion filter 200. In this case, the cooling water open/close valve 350 may remain in the closed state.

According to one example, in the ion filtering mode in which the level of the cooling water in the ion filter 200 is higher than or equal to a preset level during a process in which the cooling water is introduced into the ion filter 200, the cooling water inside the ion filter 200 may be moved to the reservoir 100 through the flow component 430. The cooling water open/close valve 350 is opened, and thus the cooling water in the ion filter 200 may be discharged toward the cooling water pump 40. When the level of cooling water in the ion filter 200 continues to rise even after all the air in the ion filter 200 is moved to the reservoir 100, the flow component 430 may serve as a passage for moving the cooling water rather than the air.

According to one example, in the ion filter discharge mode in which the electrical conductivity of the cooling water does not satisfy a preset condition due to the ion filter 200, the flow rate adjustment valve 330 may be controlled to flow the cooling water to the reservoir 100. That is, the flow rate adjustment valve 330 may be controlled to introduce the cooling water into the reservoir 100 and block the cooling water from being introduced into the ion filter 200. Thus, the level of the cooling water in the ion filter 200 may decrease, and the level of the cooling water in the reservoir 100 may increase. As the level of the cooling water in the ion filter 200 decreases, the air in the reservoir 100 may be moved to the ion filter 200 through the flow component 430. As the air in the reservoir 100 is moved to the ion filter 200 through the flow component 430, the cooling water remaining in the ion filter 200 may be moved to the reservoir 100. In order to prevent the air inside the ion filter 200 from being introduced into the cooling water pump 40, the cooling water open/close valve 350 may be maintained in the opened state until the cooling water inside the ion filter 200 reaches a preset lower limit level. When the cooling water in the ion filter 200 reaches a preset lower limit level, the cooling water open/close valve 350 may be closed. A time at which the cooling water open/close valve 350 is closed may be determined through a preset time according to the number of revolutions of the cooling water pump 40 or through a water level sensor positioned inside the ion filter 200.

According to the embodiment of the present disclosure, the cooling water open/close valve 350 may be opened until all the cooling water remaining in the ion filter 200 is discharged through the outlet port 240. In addition, as the air is moved to the ion filter 200 through the flow component 430 due to the increase of the level of cooling water in the reservoir 100, the cooling water in the ion filter 200 is discharged to the outside so that a time during which the ion filter 200 is exposed to the cooling water may be reduced.

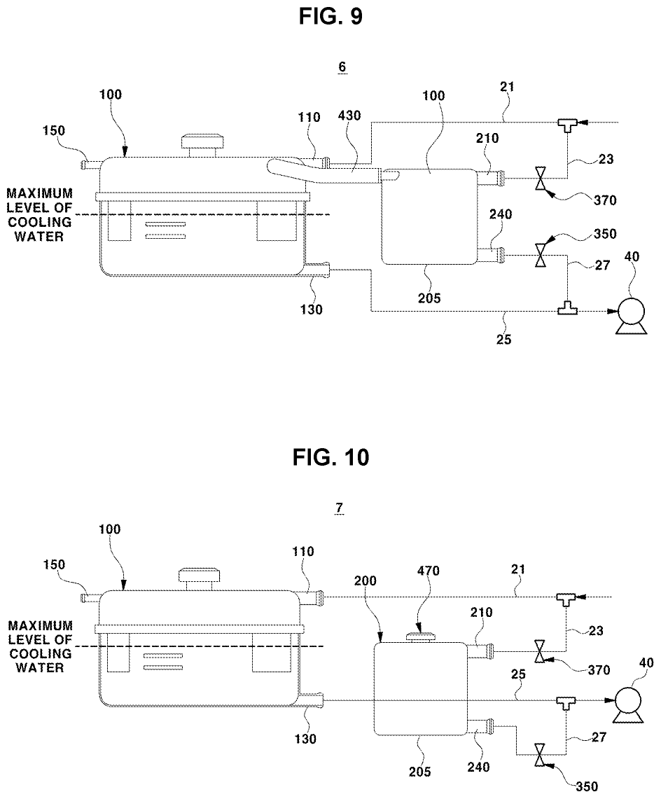

FIG. 9 is a diagram illustrating a structure for increasing durability of an ion filter according to yet another embodiment of the present disclosure. For simplicity of description, a description overlapping with FIG. 8 will be omitted.

Referring to FIG. 9, an ion filter 200 applied to a structure 6 for increasing durability of an ion filter may include an inlet port 210 connected to a second line 23 through which cooling water discharged from a fuel cell stack flows, an outlet port 240 connected to a fourth line 27 configured to discharge the cooling water from the ion filter 200 to a cooling water pump 40, and a flow component 430 configured to move the air or cooling water in conjunction with the reservoir 100. As one example, the flow component 430 may be a pipe connecting the reservoir 100 and the ion filter 200.

A flow rate adjustment valve 370 may be an on/off valve disposed on the second line 23. That is, the cooling water discharged from the fuel cell stack may always be introduced into the reservoir 100, and only when the need to remove ions from the cooling water is determined, the flow rate adjustment valve 370 is opened so that the cooling water may be introduced into the ion filter 200. After the removal of the ions from the cooling water through the ion filter 200 is completed, the flow rate adjustment valve 370 may be controlled to prevent the cooling water from being introduced into the ion filter 200. The cooling water in the ion filter 200 may be discharged toward the cooling water pump 40 through the outlet port 240, and the cooling water open/close valve 350 may be opened. In this case, until the cooling water in the ion filter 200 reaches a preset lower limit level, the cooling water open/close valve 350 may remain in an opened state, and when the cooling water in the ion filter 200 reaches the preset lower limit level, the cooling water open/close valve 350 may be closed. A time at which the cooling water open/close valve 350 is closed may be determined through a preset time according to the number of revolutions of the cooling water pump 40 or through a water level sensor positioned inside the ion filter 200.

According to the embodiment of the present disclosure, the cooling water open/close valve 350 may be opened until all the cooling water remaining in the ion filter 200 is discharged through the outlet port 240. In addition, as the air is moved to the ion filter 200 through the flow component 430 due to the increase of the level of cooling water in the reservoir 100, the cooling water in the ion filter 200 is discharged to the outside so that a time during which the ion filter 200 is exposed to the cooling water may be reduced.

FIG. 10 is a diagram illustrating a structure for increasing durability of an ion filter according to yet another embodiment of the present disclosure.

Referring to FIG. 10, an ion filter 200 applied to a structure 7 for increasing durability of an ion filter may include an inlet port 210 connected to a second line 23 through which cooling water discharged from a fuel cell stack flows, an outlet port 240 connected to a fourth line 27 configured to discharge the cooling water from the ion filter 200 to a cooling water pump 40, and a flow component 470 configured to discharge air in the ion filter 200 or introduce air into the ion filter 200 according to a change in level of cooling water in the ion filter 200. As one example, the flow component 470 may be a relief valve for discharging the air inside the ion filter 200 to the outside or introducing air into the ion filter 200. For example, the relief valve may serve to introduce the air into the ion filter 200 or discharge the air in the ion filter 200 on the basis of an internal pressure of the ion filter 200. A flow rate adjustment valve 370 may be disposed on a second line 23. However, the flow rate adjustment valve 370 may be an on/off valve disposed on the second line 23 or a three-way valve disposed at a point where a first line 21 and the second line 23 meet.

According to one example, in the bypass mode in which there is no need to flow the cooling water to the ion filter 200 according to the electrical conductivity of the cooling water, the flow rate adjustment valve 370 may be controlled to prevent the cooling water, which is discharged from a fuel cell stack, from being introduced into the ion filter 200. The sum of a flow rate of the cooling water introduced through an inlet port 110 of a reservoir 100 and a flow rate of the cooling water introduced through a degassing port 150 may always be the same as a flow rate discharged through an outlet port 130 of the reservoir 100. In this case, a cooling water open/close valve 350 disposed on a fourth line 27, which is connected to an outlet port 240 configured to discharge the cooling water to the outside of the ion filter 200, may be in a closed state.

According to one example, in the ion filter injection mode in which there is a need to flow the cooling water to the ion filter 200 according to the electrical conductivity of the cooling water, the flow rate adjustment valve 370 may be opened to flow the cooling water, which is discharged from the fuel cell stack, to the ion filter 200. Thus, the level of cooling water in the ion filter 200 may increase, and the flow component 470 may be opened so as to discharge the air in the ion filter 200 to the outside. In this case, the cooling water open/close valve 350 may remain in the closed state. Before the cooling water in the ion filter 200 reaches a preset level, the flow rate adjustment valve 370 may be opened. That is, when the cooling water in the ion filter 200 reaches the preset level, the flow rate adjustment valve 370 is closed so that the cooling water may not be introduced into the ion filter 200. A time during which the cooling water is introduced into the ion filter 200 may be determined through a preset time according to the number of revolutions of the cooling water pump 40 or through a water level sensor positioned inside the ion filter 200.

According to one example, in the ion filter discharge mode in which the electrical conductivity of the cooling water does not satisfy a preset condition due to the ion filter 200, the flow rate adjustment valve 370 may be controlled to flow the cooling water to the reservoir 100. That is, the flow rate adjustment valve 370 may be controlled to introduce into the reservoir 100 and block the cooling water from being introduced into the ion filter 200. Thus, the level of the cooling water in the ion filter 200 may decrease, and the level of the cooling water in the reservoir 100 may increase. As the level of cooling water in the ion filter 200 decreases, the flow component 470 may be opened, and as the flow component 470 is opened, the air may be introduced into the ion filter 200. In order to prevent the air inside the ion filter 200 from being introduced into the cooling water pump 40, the cooling water open/close valve 350 may be maintained in the opened state until the cooling water inside the ion filter 200 reaches a preset lower limit level. When the cooling water in the ion filter 200 reaches the preset lower limit level, the cooling water open/close valve 350 may be closed. A time at which the cooling water open/close valve 350 is closed may be determined through a preset time according to the number of revolutions of the cooling water pump 40 or through a water level sensor positioned inside the ion filter 200.

According to the embodiment of the present disclosure, as the air is introduced into the ion filter 200 according to a change in level of the cooling water in the ion filter 200 through the flow component 470, which is a relief valve, after an ion removal process of the cooling water by the ion filter 200, a phenomenon of the cooling water remaining in the ion filter 200 can be prevented.

In accordance with the embodiments of the present disclosure, since cooling water may be prevented from being always introduced into an ion filter through a flow rate adjustment valve, durability of the ion filter can be improved.

In accordance with the embodiments of the present disclosure, after a removal of ions from the cooling water is completed according to a flow of air moved from a reservoir to the ion filter through a second pipe, the cooling water remaining in the ion filter can be moved to the reservoir. Thus, a time during which the ion filter is exposed to the cooling water is reduced so that the durability of the ion filter can be improved.

In accordance with the embodiments of the present disclosure, a pipe for connecting the reservoir and the ion filter can be omitted so that the cost of manufacturing a structure for increasing durability of an ion filter can be reduced, and a total weight of the structure for increasing durability of an ion filter can be reduced.

While the embodiments of the present disclosure have been described with reference to the accompanying drawings, a person skilled in the art to which the present disclosure pertains may understand that the present disclosure can be implemented in other specific form without departing from the technical spirit and essential features of the present disclosure. Therefore, it should be understood that the above-described embodiments are not restrictive but illustrative in all aspects.

1. A structure for increasing durability of an ion filter, the structure comprising:
a reservoir configured to store cooling water discharged from a fuel cell stack;
an ion filter configured to remove ions from the cooling water discharged from the fuel cell stack;
a flow rate adjustment valve positioned between the ion filter and the fuel cell stack;
a first pipe through which the cooling water flows from the ion filter to the reservoir; and
a second pipe through which air or the cooling water is moved between the reservoir and the ion filter according to a change in level of the cooling water inside the ion filter.

2. The structure of claim 1, wherein the flow rate adjustment valve is a three-way valve configured to control a flow rate of the cooling water to the ion filter or the reservoir.

3. The structure of claim 1, wherein:
the flow rate adjustment valve is configured to introduce the cooling water into the ion filter based on electrical conductivity of the cooling water or insulation resistance of the fuel cell stack; and
when the electrical conductivity of the cooling water or the insulation resistance of the fuel cell stack satisfies a preset condition, the flow rate adjustment valve is configured to introduce the cooling water into the ion filter and block the cooling water from being introduced into the reservoir.

4. The structure of claim 1, wherein:
when a level of the cooling water inside the ion filter increases, the air inside the ion filter is moved to the reservoir; and
when the level of cooling water inside the ion filter decreases, the air inside the reservoir is moved to the ion filter.

5. The structure of claim 4, wherein, when the level of cooling water inside the ion filter is higher than or equal to a preset level, the cooling water inside the ion filter is moved to the reservoir through the second pipe.

6. The structure of claim 4, wherein, when the cooling water is not introduced into the ion filter and the level of cooling water inside the ion filter decreases, the cooling water remaining inside the ion filter is discharged to the reservoir through the first pipe by the air moved from the reservoir to the ion filter.

7. The structure of claim 1, wherein a bottom surface of the ion filter is positioned higher than a maximum level of the cooling water in the reservoir.

8. The structure of claim 1, further comprising:
an inlet port of the reservoir, which is connected to a first line connecting the fuel cell stack and the reservoir; and
an inlet port of the ion filter, which is connected to a second line which branches from the first line and is connected to the ion filter,
wherein a diameter of the inlet port of the ion filter is greater than a diameter of the first pipe.

9. The structure of claim 8, wherein the flow rate adjustment valve includes an on/off valve positioned on the second line.

10. A structure for increasing durability of an ion filter, the structure comprising:
a reservoir configured to store cooling water discharged from a fuel cell stack;
an ion filter configured to remove ions from the cooling water discharged from the fuel cell stack; and
a flow rate adjustment valve configured to control flow of the cooling water, which is discharged from the fuel cell stack, to at least one of the ion filter or the reservoir,
wherein the ion filter includes an outlet port configured to control the flow of the cooling water to the reservoir, and a flow port through which air or the cooling water is moved between the reservoir and the ion filter; and
the outlet port and the flow port are directly connected to the reservoir.

11. The structure of claim 10, wherein the air is moved between the reservoir and the ion filter through the flow port according to a change in level of the cooling water inside the ion filter.

12. The structure of claim 10, wherein:
the flow rate adjustment valve includes a first port directly connected to the ion filter and configured to control flow of the cooling water to the ion filter, and a second port directly connected to the reservoir and configured to control the flow of the cooling water to the reservoir; and
the ion filter includes an inlet port connected to the first port of the flow rate adjustment valve and configured to introduce the cooling water.

13. The structure of claim 10, wherein:
the flow port is positioned higher than the outlet port based on a bottom surface of the ion filter; and
the bottom surface of the ion filter is inclined based on a maximum level of the cooling water in the reservoir.

14. A structure for increasing durability of an ion filter, the structure comprising:
a reservoir configured to store cooling water discharged from a fuel cell stack;
an ion filter configured to remove ions from the cooling water discharged from the fuel cell stack;
a flow rate adjustment valve positioned between the ion filter and the fuel cell stack; and
a flow component configured to discharge air in the ion filter, introduce the air into the ion filter, or control flow of the cooling water from the ion filter to the reservoir according to a change in a level of cooling water inside the ion filter;
wherein the ion filter includes an inlet port connected to the flow rate adjustment valve, and an outlet port configured to discharge the cooling water to a line through which the cooling water discharged from the reservoir flows.

15. The structure of claim 14, further comprising:
a first line through which the cooling water flows, which is discharged from the fuel cell stack, to the reservoir;
a second line which branches from the first line and through which the cooling water flows to the ion filter;
a third line through which the cooling water flows, which is discharged from the reservoir, to a cooling water pump; and
a fourth line connected to the third line to connect to the outlet port of the ion filter.

16. The structure of claim 15, wherein the flow rate adjustment valve includes a three-way valve positioned at a point connecting the first line and the second line or the flow rate adjustment valve includes an on/off valve disposed on the second line.

17. The structure of claim 15, wherein a cooling water open/close valve is provided on the fourth line to control a flow of the cooling water discharged from the ion filter.

18. The structure of claim 17, wherein, when the cooling water is not introduced into the ion filter by the flow rate adjustment valve, the cooling water open/close valve is closed when the level of the cooling water in the ion filter is lower than a preset lower limit level.

19. The structure of claim 14, wherein the flow component is a passage which connects the reservoir and the ion filter and through which the air or cooling water is moved between the reservoir and the ion filter.

20. The structure of claim 14, wherein the flow component is a relief valve configured to discharge the air inside the ion filter to the outside or introduce the air into the ion filter.
